(19) United States
(12) Patent Application Publication
(10) Pub. No.: US 2022/0270538 A1
(43) Pub. Date: Aug. 25, 2022

(54) DISPLAY MODE SETTING DETERMINATIONS

(71) Applicant: Hewlett-Packard Development Company, L.P., Spring, TX (US)

(72) Inventors: Chia-Cheng Lin, Taipei City (TW); Hsin-Jen Lin, Taipei City (TW); Heng-Fu Chang, Taipei City (TW); Tsue-Yi Huang, Taipei City (TW)

(73) Assignee: Hewlett-Packard Development Company, L.P., Spring, TX (US)

(21) Appl. No.: 17/635,573

(22) PCT Filed: Oct. 18, 2019
(86) PCT No.: PCT/US2019/056932

§ 371 Date: Feb. 15, 2022

(51) Int. Cl. G09G 3/20

(52) U.S. Cl. CPC G09G 3/2096; G09G 2320/08; G09G 2360/06; G09G 2360/04

(57) ABSTRACT

Examples for generating a common video signal for an integrated GPU and the graphical processing device, based on a common display mode setting, are described. In an example, a common display mode setting is determined based on a first set of display mode settings supported by the integrated GPU and a second set of display mode settings supported by the graphical processing device. Based on the common display mode setting, video signals for the integrated GPU and the graphical processing device are generated.

### BACKGROUND

Computing devices, such as personal computers, laptops, notebooks, etc., may be coupled to a plurality of display devices, such as display monitors, projectors, or such similar video output devices. Such multiple display devices may permit the user to extend the display available on one display device to another. In other cases, the user may also replicate or ‘clone’ the visual output rendered onto one display device, onto another display device.

### BRIEF DESCRIPTION OF THE DRAWINGS

The following detailed description references the drawings, wherein:

FIG. 1 illustrates a computing device for generating a common video signal for an integrated graphical processing unit and for a graphical processing device, according to an example;

FIG. 2 illustrates a computing device for generating a common video signal for an integrated graphical processing unit and for a graphical processing device, according to another example;

FIG. 3 illustrates a computing device within an example computing environment for generating a common video signal for an integrated graphical processing unit and for a graphical processing device, according to an example;

FIG. 4 illustrates a method for generating a common video signal for an integrated graphical processing unit and for a graphical processing device, according to an example; and

FIG. 5 illustrates a non-transitory computer readable medium for cutting-off power supply of an electronic device in a standby mode, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A computing device generally includes a display for providing the visual output. The display may be coupled with the computing device (e.g., in the case of a standalone desktop computer) through a wired connection, or may be integrated within the housing of the computing device (e.g., in the case of a laptop, portable computing device). The computing devices may be further coupled or connected with a second display device which supplements a first display device of the computer device. In such cases, the visual output being rendered onto the first display may be replicated or ‘cloned’ onto a second display.

Display related processing within the computing device may be performed by a Graphics Processing Unit (GPU). The GPU may be considered as a programmable logic circuit for performing display related functions to drive or control the display, and accordingly providing a visual output. In one case, a GPU may be integrated within the motherboard of the computing devices (referred to as an integrated GPU). In certain other cases, an additional GPU, referred to as a discrete GPU (or discrete GPU), may be installed within the computing device. The discrete GPU is may be in the form an expansion card/graphic card which may be fitted or installed into an expansion slot present on the motherboard of the computing device. The discrete GPU thereafter may augment the graphical processing capability of the computing device. The discrete GPU may further include one or more ports through which the second display may be connected to the computing device. In such instances, the first display may be controlled by the integrated GPU, and the second display may be controlled by the discrete GPU.

Cloning the visual output provided on the first display may pose challenges during pre-boot phase of the computing device. A pre-boot phase may be considered as the phase which involves the hardware initialization of components at start-up. The pre-boot phase may be performed by a firmware provided within the computing device. During the pre-boot phase, a user interface or a start-up screen may be rendered which may depict, amongst other information, certain device related information.

During a pre-boot phase, some of the graphical processing units (also referred to as graphic adapters) of the computing device may not be initialized. For instance, during the pre-boot phase, the computing device may initialize the integrated GPU. Therefore, if multiple displays are coupled to the computing device, such displays which are controlled by the initialized GPUs would display the start-up screen, while the other displays connected to other GPUs may not be able to. For example, generally the integrated GPU of the computing device may get initialized prior to the discrete GPU. In such a case, the first display coupled to the integrated GPU would render the start-up screen during the pre-boot phase while the second display may provide a blank screen. Although the booting process may be configured such that the discrete GPU is to initialize first, in some cases, some of the displays connected to the computing device may display the same start-up screen during the pre-boot phase, while the other displays may not.

Furthermore, in certain other instances, the computing device may be coupled to a graphical processing device (e.g., an external GPU or a docking station). A graphical processing device may be generally understood to include devices which allows the computing device to be connected to one or more peripheral or displays, and may also include embedded graphical processing units for handling display related functions. The graphical processing devices, in the case of docking station, generally extend the display functionality using USB-based graphics display specifications. This permits such docking stations to be connected to displays using USB-based protocols. Therefore, the output being displayed on the first display may be cloned or replicated onto another second display coupled to the computing device through the docking station.

However, the second display may not be able to display the start-up screen provided during the pre-boot phase. This may occur since the device drivers corresponding to the USB-based graphics display specifications are available and operate once the computing device has booted completely. As a result, certain encryption mechanisms (e.g., BitLocker) involving an authentication procedure which is to be performed during the pre-boot phase may be accessible through the first display. In cases where the user couples the computing device (e.g., a laptop) to the docking station and then powers on the computing device, the user may have to open the lid of the computing device in order to access and complete the authentication process as indicated above.

Example approaches for cloning a display of a computing device across a plurality of display devices during the pre-boot phase, are described. The computing device may include an integrated GPU, and may further be coupled to a graphical processing device. The graphical processing device may be either a discrete GPU, external GPU (eGPU), or an additional graphical processing device, such as a docking station, coupled to the computing device. In case of a discrete GPU, the graphical processing device may be present within the computing device. Returning to the present example, the integrated GPU may be connected to a first display, with the graphical processing device being connected to a second display.

In an example, during pre-boot phase, the integrated GPU and the graphical processing device, may be detected. In an example, on detecting the graphical processing device an identifier corresponding to the detected graphical processing device may be obtained and may be stored in a linked list. The link list, amongst other information, may also include information pertaining to plurality of graphical processing units which may be coupled to a given computing device. Once the integrated GPU and the graphical processing device are detected, the computing device may retrieve a first set of display mode settings corresponding to the integrated GPU. In a similar manner, on detecting the presence of the graphical processing device, the computing device may also retrieve a second set of display mode settings corresponding to the graphical processing device. The display mode settings may be considered as settings based on which an output by either the integrated GPU or the graphical processing device may be generated. An example of such display mode settings includes, but is not limited to, display resolution based on which the visual output is to be rendered on a display device.

With both the first set and the second set of display mode settings determined, computing device may further identify a common display mode setting which is supported by both the integrated GPU and the graphical processing device, or a combination thereof. For example, a common setting which is present in the first set and the second set of display mode settings may be selected as the common display mode setting. Once identified, the common display mode setting may then be used to configure the first display and the second display, which may be coupled to the integrated GPU and the graphical processing device, respectively.

With the first display device and the second display device configured based on the common display mode setting, the computing device may generate common video signal for the integrated GPU and the graphical processing device. The common video signal may be provided to the frame buffer of the integrated GPU and the graphical processing device, for generating a common display on the first display and the second display.

As would be noted, the present approaches allow for multiple graphical processing units supporting different displays to be initialized during the pre-boot phase of the computing device. The initialization of the displays, as per the present examples, is performed independent of any display priority. Furthermore, since the display configurations of the different displays are matched, the output display during the pre-boot phase is coherent and consistent across the displays. Still further, approaches of the present subject matter also allow the display to be replicated onto displays which may be coupled to the computing device through other types of graphical processing devices, such as a docking station.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

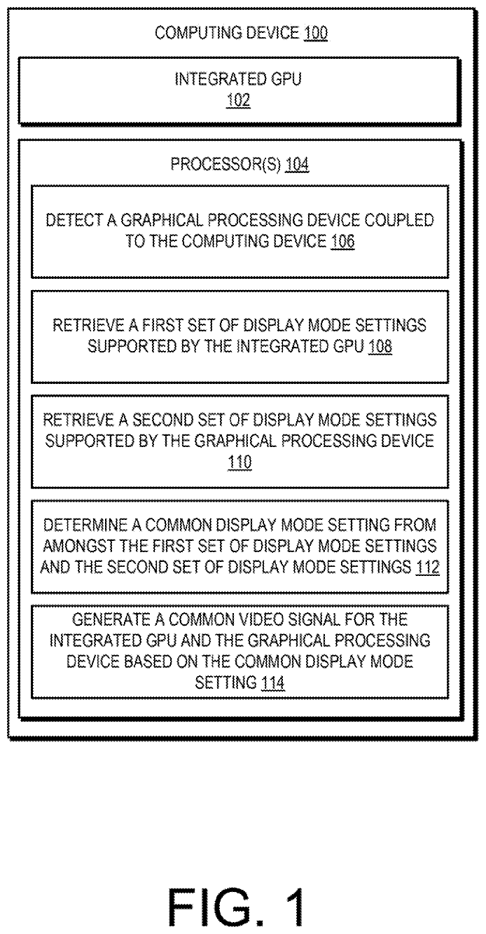

The manner in which the example computing devices are implemented are explained in detail with respect to FIGS. 1-5. While aspects of described computing devices can be implemented in any number of different electronic devices, environments, and/or implementations, the examples are described in the context of the following example system(s). It is to be noted that drawings of the present subject matter shown here are for illustrative purposes and are not to be construed as limiting the scope of the subject matter claimed.

FIG. 1 illustrates a computing device 100 for generating a common video signal for an integrated graphical processing unit and for a graphical processing device, according to an example. The computing device 100 may be a desktop computer. In the example as illustrated, the computing device 100 may further include an integrated GPU 102 and processor(s) 104.

The integrated GPU 102 may include programmable logic circuit specialized for performing display related processing. In operation, the central processing unit (CPU), i.e., the processor(s) 104 may provide one or more display instructions pertaining to the content which is to be rendered. The display instructions may be generated as any instructions which are generated by the integrated GPU 102 based on which visual content is to be rendered. Such display instructions are processed by the integrated GPU 102 to render the corresponding content onto the display device. An integrated GPU 102 may be integrated within the circuitry of the motherboard of the computing devices or may be implemented as logical block within the processor(s) 104 itself.

The processor(s) 104 may be implemented as microprocessors, microcomputers, microcontrollers, digital signal processors, central processing units, state machines, logic circuitries, and/or any devices that manipulate signals based on operational instructions. Among other capabilities, the processor(s) 104 is configured to fetch and execute computer-readable instructions stored in a memory, for example, in order to generate a common video signal for the integrated GPU 102 and for a graphical processing device coupled to the computing device 100. In another example, the processor(s) 104 may initialize the firmware as the computing device 100 is powered on, in order to generate a common video signal for the integrated GPU 102 and the graphical processing device.

To this end, the processor(s) 104 may initially detect a graphical processing device (not shown in FIG. 1) which may be coupled to the computing device 100. In an example, on detecting the graphical processing device, the processor(s) 104 may obtain an identifier of the detected graphical processing device and store it in a linked list. The link list, in another example, may also include information pertaining to plurality of graphical processing units which may be coupled to a given computing device 100. The graphical processing device may be any device which allows the computing device to be connected to one or more peripheral or displays. The graphical processing device may additionally implement one or more display related functions. The graphical processing device may further include embedded graphical processing units for handling display related functions. In another example, the graphical processing device may be a discrete GPU which is installed within the computing device 100. The graphical processing device may also be an external GPU or an eGPU. An eGPU may be implemented as a standalone unit which may be coupled to the computing device 100 through a wired connection, and may be connected between the computing device 100 and the display device. In yet another example, the graphical processing device may be implemented as a docking station which may be utilized to extend the number of display ports which may be available on the computing device 100 for connecting multiple display devices.

Returning to the present example, the processor(s) 104 may perform a series of functions, for example, in response to execution of one or more executable instructions provided within the computing device 100. The computing device 100 may be coupled to a graphical processing device (not shown in FIG. 1). In an example, the computing device 100 may detect such a graphical processing device which is coupled to the computing device 100 (represented as block 106). In parallel, the processor(s) 104 may also retrieve a first set of display mode settings supported by the integrated GPU 102 (represented as block 108). In a similar manner, the second set of display mode settings supported by the graphical processing device may then be determined (represented as block 110). The display mode settings may be considered as such settings based on which a visual output may be generated by either the integrated GPU 102 or the graphical processing device.

Once the first set and the second set of display mode settings are obtained, the processor(s) 104 may determine a common display mode setting based on the first set and the second set of display mode settings (represented as block 112). In an example, the processor(s) 104 may compare the first set of display mode settings and the second set of display mode settings to determine the common display mode setting. Based on the identified common display mode setting, the processor(s) 104 may generate a common video signal for the integrated GPU 102 and the graphical processing device (represented as block 114). In an example, the processor(s) 104 may write image data pertaining to the common video signal to the frame buffer of both the integrated GPU 102 and the graphical processing device. Based on the image data in the frame buffer of the integrated GPU 102, the visual output may subsequently be rendered. In an example, the common display mode setting comprises a display resolution supported by the integrated GPU, the graphical processing device, or a combination thereof.

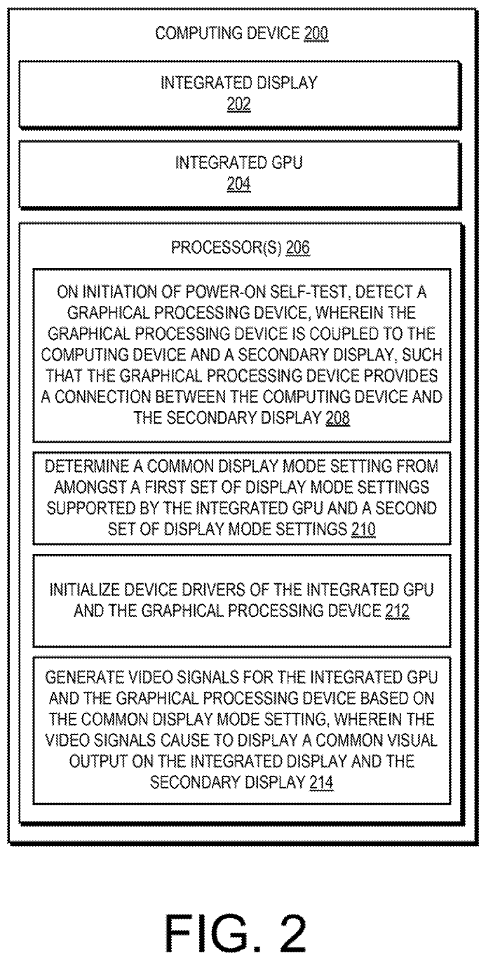

FIG. 2 illustrates a computing device 200 for generating a common video signal for an integrated graphical processing unit and for a graphical processing device, according to another example. In the example as illustrated, the computing device 200 may further include an integrated display 202, integrated GPU 204, and processor(s) 206. The integrated display 202 may be any display panel which is integrated within the housing or the circuitry of the computing device 200. For example, the integrated display 202 may be display screen of a personal computing device such as a laptop, portable computers, etc. In such cases, the integrated display 202 may be driven or controlled by the integrated GPU 204. The integrated GPU 204 included within the computing device 200, may be similar to the integrated GPU 204 as described in the context of the computing device 200.

The processor(s) 206, similar to processor(s) 104, may implement one or more functions which enable generation of a common video signal for the integrated display 202 and for another graphical processing device. It may be the case that the computing device 200 may be further coupled to a second display device. The second display device (interchangeably referred to as second display) may be any visual output device onto which an output generated by the computing device 200 may be rendered.

In an example, the processor(s) 206 may detect the presence of a graphical processing device which may be coupled to the computing device 200. In the present example, the detection of a graphical processing device may be performed on initiation of a Power-On-Self-test (POST) booting of the computing device 200 (represented as block 208). The POST may be initiated in response to the commencement of the booting of the computing device 200. During this phase (i.e., the pre-boot phase) the computing device 200 may also detect the integrated GPU 204. In an example, on detecting the graphical processing device, the processor(s) 206 may obtain an identifier of the detected graphical processing device and store it in a linked list. The link list, in another example, may also include information pertaining to plurality of graphical processing units which may be coupled to a given computing device 200.

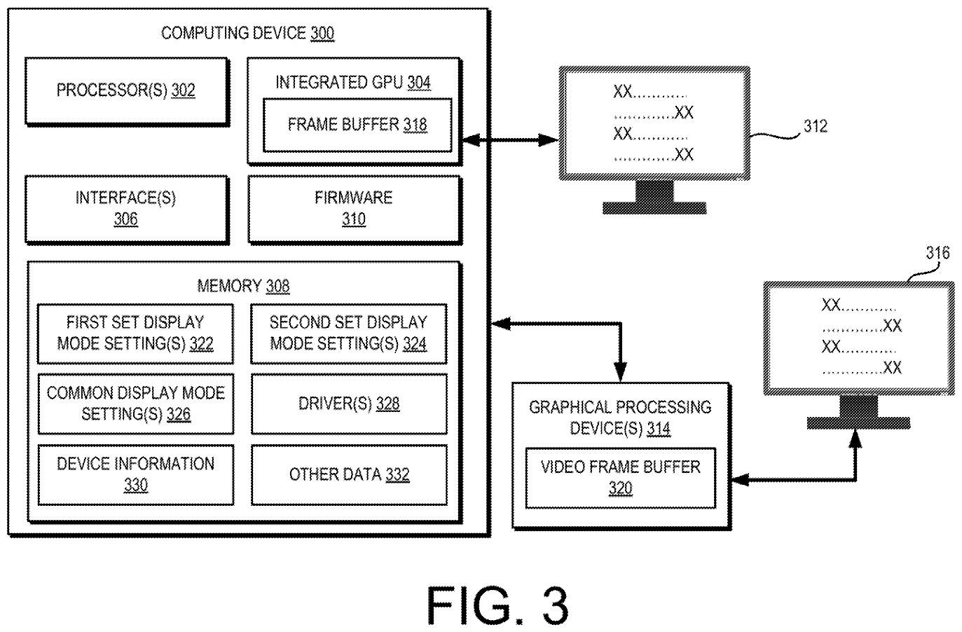

Once the integrated GPU 204 and the graphical processing device have been detected, the processor(s) 206 may further determine a common display mode setting from supported display mode settings of the integrated GPU 204 and the graphical processing device (represented as block 210). For example, the processor(s) 206 may obtain a first set and a second set of display mode settings corresponding to the integrated GPU 204 and the graphical processing device, respectively. With the common display mode setting determined, the processor(s) 206 may obtain and further initialize one or more drivers of the integrated GPU 204 and the graphical processing device (represented as block 212). Thereafter, a common video signal for rendering a common visual output on the integrated display 202 (which is coupled with the integrated GPU 204) and the second display (coupled to the second display) is generated, and provided to respective display devices (represented as block 214). Further aspects of the present subject matter are now described in further details in conjunction with example computing environment, illustrated in FIG. 3.

FIG. 3 illustrates a computing environment comprising a computing device 300 for generating a common video signal for an integrated graphical processing unit and for a graphical processing device. The computing device 300 may include a processor(s) 302, integrated GPU 304, interface(s) 306, memory 308, and firmware 310. The integrated GPU 304 may be considered as a graphical processing unit which is provided on the motherboard of the computing device 300. The integrated GPU 304 in its operation may process data to generate one or more images which is then used for generating the output onto a visual output device.

The interface(s) 306 may allow the connection or coupling of the computing device 300 with one or more other devices, through a wired (e.g., LAN) connection or through a wireless connection (e.g., Bluetooth®, WiFi). In an example, the integrated GPU 304 of the computing device 300 may be further coupled to a first display(s) 312. The first display(s) 312 may be any display integrated within the computing device (e.g., in the case of a laptop), a stand-alone display monitor, or a similar output connected with the computing device 300. The integrated GPU 304 is such that it controls the display of the output onto the first display(s) 312. The computing device 300 may be further coupled to a graphical processing device(s) 314. The graphical processing device(s) 314 may be considered as any device for performing display related functions, and may be utilized for coupling the computing device 300 with second display(s) 316. The graphical processing device(s) 314 may include devices such as a docking station or an external GPU, which permit the computing device 300 to be coupled to the one or more second display(s) 316. In another example, the graphical processing device(s) 314 may be also be a discrete GPU which is installed within the computing device 300, without deviating from the scope of the present subject matter.

The integrated GPU 304 may be further provided with a frame buffer 318. In a similar manner, the graphical processing device(s) 314 may also be provided with a video frame buffer 320. During operation, image data which is to be rendered onto the appropriate display device is written onto the respective frame buffer. For example, the output from the integrated GPU 304 would be written to the frame buffer 318 based on which the video output is provided onto the first display(s) 312. In a similar manner, the output from the graphical processing device(s) 314 would be written to the video frame buffer 320 based on which the video output is provided onto the second display(s) 316.

The memory 308 on the other hand further includes the first set of display mode setting(s) 322, the second set of display mode setting(s) 324, common display mode setting 326, driver(s) 328, device information 330, and other data 332.

The generation of a common video signal for an integrated graphical processing unit and for a graphical processing device during the pre-boot phase is described. In operation, the computing device 300 may be powered on. When the computing device 300 is powered on, the processor(s) 302 may initiate the firmware 310 for commencing the pre-boot phase. During the pre-boot phase, the firmware 310 may initiate Power-On-Self-Test (POST) during which different hardware which may be connected to the computing device 300 may be detected and checked.

Through the firmware 310, the processor(s) 302 may initially detect the integrated GPU 304 present within the computing device 300. The processor(s) 302 may further continue to detect one or more other graphic adaptors, such as the graphical processing device(s) 314, that may be coupled to the computing device 300. Once detected, information pertaining to such other devices may further written to device information 330. In an example, on detecting the graphical processing device(s) 314, the processor(s) 302 may obtain an identifier of the detected graphical processing device(s) 314 and store it in a linked list. The link list, in another example, may also include information pertaining to plurality of graphical processing units which may be coupled to a given computing device 300, and may be stored in device information 330.

Considering the present example, the processor(s) 302 may detect the integrated GPU 304 and the graphical processing device(s) 314. Once detected, the processor(s) 302 may further obtain the first set of display mode setting(s) 322. The first set of display mode setting(s) 322 may include one or more settings based on which visual output may be generated by the integrated GPU 304 for rendering onto the first display(s) 312. The processor(s) 302 may further proceed to obtain the second set of display mode setting(s) 324 which corresponding to the settings for the graphical processing device(s) 314, based on which graphical processing device(s) 314 may generate a visual output for rendering onto the second display(s) 316. Examples of the display settings may include, but are not limited to, display resolution or the amount of frame buffer, which may be supported by the graphical processing units, such as the integrated GPU 304 or the graphical processing device(s) 314.

In an example, the first set of display mode setting(s) 322 and the second set of display mode setting(s) 324 (collectively referred to as settings 322, 324) may be determined based on the configuration or certain display related attributes of the displays which may be coupled to the computing device 300. For example, the integrated GPU 304 is coupled to the first display(s) 312. The first display(s) 312 may be coupled to the integrated GPU 304 through interface(s) 306. The processor(s) 302 may determine the resolution supported by the first display(s) 312. Based on resolutions supported by the first display(s) 312, the processor(s) 302 may obtain the first set of display mode setting(s) 322 which in turn would be supported by the integrated GPU 304. In a similar manner, during the pre-boot phase the processor(s) 302 may further determine the resolutions which may be supported by the second display(s) 316 to determine the second set of display mode setting(s) 324. It may be noted that the present example has been described in the context of computing device 300 being coupled to the first display(s) 312 and the second display(s) 316. However, further displays may also be coupled to the computing device 300 without deviating from the scope of the present subject matter. In such a case, the processor(s) 302 may obtain the supported display resolutions for such additional displays to obtain the settings 322, 324. For example, if two displays are connected to the integrated GPU 304, the first set of display mode setting(s) 322 may be based on the display resolutions supported by the two displays.

Returning to the operation of the computing device 300, with the first set of display mode setting(s) 322 retrieved, the processor(s) 302 may select a setting from amongst the first set of display mode setting(s) 322 as a valid setting. The valid setting may be selected based a predefined criterion. For example, the processor(s) 302 may select the highest display resolution setting provided within the first set of display mode setting(s) 322 as the valid setting. Once selected, the processor(s) 302 may compare the valid setting with the one or more settings within the second set of display mode setting(s) 324. The processor(s) 302 may then select the setting which matches the valid setting as the common display mode setting 326. It may be noted that valid setting may alternatively be selected from the second set of display mode setting(s) 324 without deviating from the scope of the present subject matter. In such instances, the valid setting (thus selected from the second set of display mode setting(s) 324) may then be compared with the first set of display mode setting(s) 322 to determine the common display mode setting 326. In an example, the common display mode setting 326 comprises a display resolution supported by the integrated GPU 304, the graphical processing device(s) 314, or a combination thereof.

In another example, the processor(s) 302 may select the highest supported settings from the second set of display mode setting(s) 324 as the second valid setting. The processor(s) 302 may then compare the valid setting and the second valid setting. If the valid setting and the second valid setting match, the same may be selected as the common display mode setting 326. In case the valid settings and the second valid settings not matching, the processor(s) 302 may set a default setting as the valid setting, based on which a common display mode setting 326 may be determined by comparing the valid setting with the settings of the second set of display mode setting(s) 324.

Once the common display mode setting 326 is determined, the processor(s) 302 may cause image data to be communicated to the frame buffer 318 of the integrated GPU 304. Based on the image data, the frame buffer 318 generates a video output which conforms with the common display mode setting 326. The video output may then be provided to the first display(s) 312 for rendering. The image data may include any predefined visual output. In an example, the visual output which is to be displayed may be stored in other data 332. In parallel, the processor(s) 302 also may cause the same image data to be communicated to the video frame buffer 320 of the graphical processing device(s) 314. The frame buffer may then generate a video output based on the common display mode setting 326 and the image data retrieved from other data 332. The frame buffer of the graphical processing device(s) 314 may then generate the video output for rendering onto the second display(s) 316. Since the image data and the common display mode setting 326 is consistent between the first display(s) 312 and the second display(s) 316, the visual output rendered thereupon is also consistent. Based on the examples described above, the visual output rendered across different graphic adapters may be rendered during the pre-boot phase.

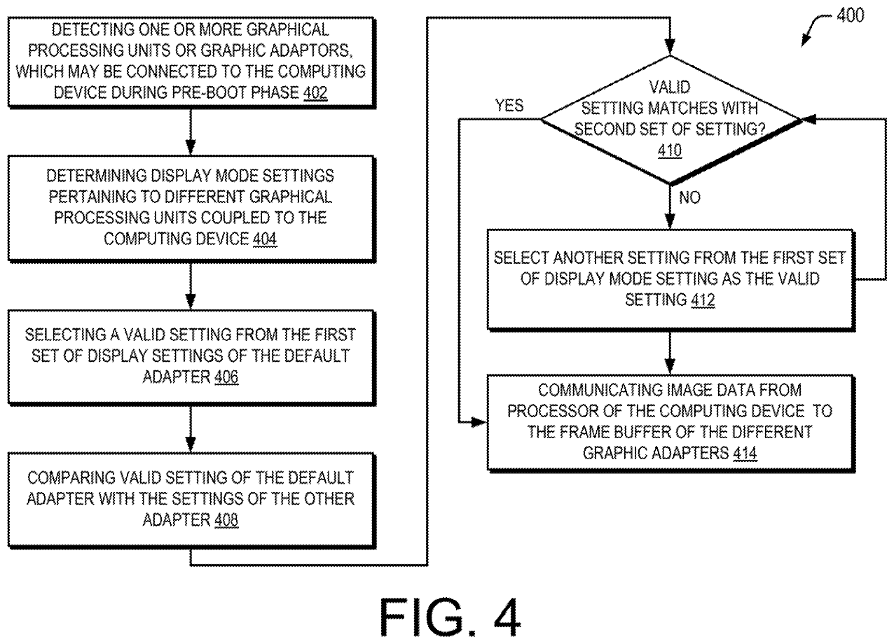

FIG. 4 illustrates a method 400 for generating a common video signal for an integrated graphical processing unit and for a graphical processing device. Although the method 400 may be implemented in a variety of computing devices, for the ease of explanation, the present description of the example method 400 is provided in reference to the above-described computing devices 100, 200 or 300.

The order in which the method 400 is described is not intended to be construed as a limitation, and any number of the described method blocks may be combined in any order to implement the method 400, or an alternative method. It may be understood that blocks of the method 400 may be performed by the computing device 100. The blocks of the method 400 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

At block 402, one or more graphical processing units or graphic adaptors, which may be connected to the computing device, may be detected during pre-boot phase. The pre-boot phase is initiated on powering on of the computing device. For example, when the computing device 300 is powered on, the processor(s) 302 may detect one or more graphic adapters, such as the integrated GPU 304 or the graphical processing device(s) 314. The detection of the integrated GPU 304 or the graphical processing device(s) 314 coupled to the computing device 300 may be implemented using a firmware 310, which may be programmed into a read-only memory of the computing device 300. Examples of such a firmware 310 includes, but are not limited to, BIOS (Basic Input/Output System) or Unified Extensible Firmware Interface (UEFI) based firmware.

At block 404, display mode settings pertaining to different graphical processing units coupled to the computing device may be determined. For example, the processor(s) 302 may determine a first set of display mode setting(s) 322 which may be supported by the integrated GPU 304. Display mode settings may be considered as such settings based on which the integrated GPU 304 may generate a visual output for rendering onto a display (such as first display(s) 312), with which it may be coupled. In a similar manner, the processor(s) 302 may also determine a second set of display mode setting(s) 324 supported by the graphical processing device(s) 314. In an example, the settings 322, 324 may be determined based on the one or more display related attributes of display devices to which the integrated GPU 304 and the graphical processing device(s) 314 may be coupled. For example, the processor(s) 302 may determine display resolutions which may be supported by the first display(s) 312 (coupled to the integrated GPU 304) and the second display(s) 316 (coupled to the graphical processing device(s) 314) to determine the settings 322, 324.

At block 406, a valid setting may be selected from either of the display settings of either the integrated GPU or the graphical processing device coupled to the computing device. For example, the processor(s) 302 may designate the integrated GPU 304 as a default adapter. Thereafter, the processor(s) 302 may select a setting from the first set of display mode setting(s) 322 as a valid setting, based on predefined selection criteria. In another example, the processor(s) 302 may select the highest supported setting as the valid setting. It may be noted that selection of the integrated GPU 304 as the default adapter is one of the other possible examples. Any other adapter, such as the graphical processing device(s) 314, may be also be designated as a default adapter without limiting the scope of the present subject.

At block 408, the valid setting of the default adapter may be compared with the settings of the other adapter. For example, the processor(s) 302 may compare the valid setting with the second set of display mode setting(s) 324. If the valid setting matches with any setting within the second set of display mode setting(s) 324 (‘Yes’ path from block 408), the matched setting is identified as the common display mode setting 326 (block 410). On identification of the matched setting as the common mode setting, the method may proceed to block 414 wherein which a visual output is to be generated.

If the valid setting does not match with any setting within the second set of display mode setting(s) 324 (‘No’ path from block 408), the processor(s) 302 may select another setting from the first set of display mode setting(s) 322 as the valid setting (block 412). The method recurses back to block 410 where the processor(s) 302 may compare the valid setting with the settings in the second set of display mode setting(s) 324. The method may be repeated in this manner to identify the common display mode setting 326.

At block 414, image data from processor of the computing device may be communicated to the frame buffer of the different graphic adapters. For example, based on common display mode setting 326, the processor(s) 302 may cause image data to be communicated to the frame buffer 318 of the integrated GPU 304 and to the video frame buffer 320 of the graphical processing device(s) 314. Both the frame buffer 318 and the video frame buffer 320 generates a common video output which conforms with the common display mode setting 326. The video output may then be provided to the first display(s) 312 (coupled to the integrated GPU 304) and the second display(s) 316 (coupled to the graphical processing device(s) 314) for rendering. Since the image data and the common display mode setting 326 is consistent between the first display(s) 312 and the second display(s) 316, the visual output rendered is also the same. Although described in the context of integrated GPU 304 and the graphical processing device(s) 314, it may be noted that similar approaches may also be implemented for additional graphical processing device(s) 314, for example, discrete GPU which may be installed within the computing device 300, an external GPU which may be coupled to the computing device 300, or such other devices. The approaches as described may be employed for such other examples without any deviation from the scope of the present subject matter.

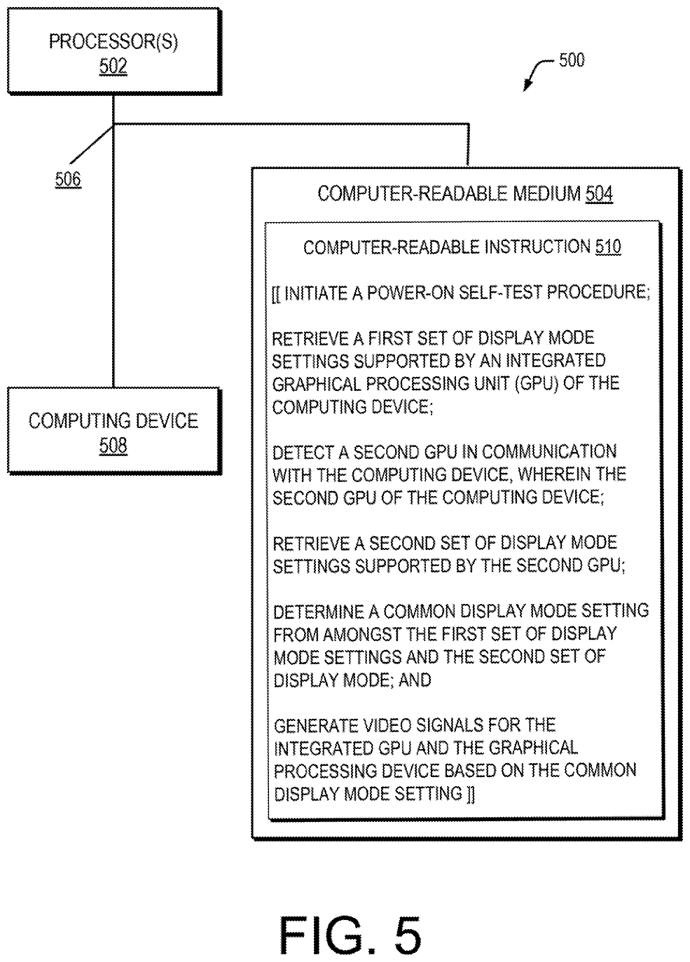

FIG. 5 illustrates a computing environment 500 implementing a non-transitory computer readable medium for generating a common video signal for an integrated graphical processing unit and for a graphical processing device. In an example, the computing environment 500 includes processor(s) 502 communicatively coupled to a non-transitory computer readable medium 504 through a communication link 506. In an example implementation, the computing environment 500 may be for a computing environment comprising a computing device 300, as illustrated in FIG. 3. In an example, the processor(s) 502 may have one or more processing resources for fetching and executing computer-readable instructions from the non-transitory computer readable medium 504. The processor(s) 502 and the non-transitory computer readable medium 504 may be implemented, for example, in computing device 100, 200 or 300.

The non-transitory computer readable medium 504 may be, for example, an internal memory device or an external memory device. In an example implementation, the communication link 506 may be a network communication link, or other communication links, such as a PCI Express or USB-C interfaces. The processor(s) 502 and the non-transitory computer readable medium 504 may also be communicatively coupled to a computing device 508 over the network. The computing device 508 may be implemented, for example, as computing device 300.

In an example implementation, the non-transitory computer readable medium 504 includes a set of computer readable instructions 510 which may be accessed by the processor(s) 502 through the communication link 506 and subsequently executed to perform acts for feature-based reporting of software versions.

Referring to FIG. 5, in an example, the non-transitory computer readable medium 504 includes instructions 510 that cause the processor(s) 502 to initiate a power-on self-test (POST) procedure for a computing device, such as the computing device 300. The POST procedure may be initiated in response to powering on of the computing device 300. As the computing device 300 is in the process of booting up (i.e., during the pre-boot phase), the instructions 510 may further result in retrieving a first set of display mode settings supported by an integrated graphical processing unit, such as the integrated GPU 304, of the computing device 300. Thereafter, the instructions 510 may cause detection of second GPU of the computing device. In an example, the second GPU may include a discrete GPU which is installed within the computing device 300.

Once the second GPU is detected, the instructions 510 may result in retrieving a second set of display mode settings, such as second set of display mode setting(s) 324, supported by the second GPU. With the first set of display mode setting(s) 322 and the second set of display mode setting(s) 324 retrieved, the instructions 510 may result in determining a common display mode setting from amongst the first set of display mode settings and the second set of display mode. In an example, the instructions 510 may cause the processor(s) 302 to compare the first set of display mode setting(s) 322 and the second set of display mode setting(s) 324 to determine a common display mode setting 326. Once the common display mode setting 326 is determined, the instructions 510 may cause the processor(s) 302 to generate video signals for the integrated GPU (e.g., the integrated GPU 304) and the second GPU based on the common display mode setting.

Although examples for the present disclosure have been described in language specific to structural features and/or methods, it should be understood that the appended claims are not necessarily limited to the specific features or methods described. Rather, the specific features and methods are disclosed and explained as examples of the present disclosure.

We claim:

1. A computing device comprising:
an integrated graphical processing unit (GPU);
a processor coupled to the integrated GPU, wherein the processor is to,
detect a graphical processing device coupled to the computing device;
retrieve a first set of display mode settings supported by the integrated GPU;
retrieve a second set of display mode settings supported by the graphical processing device;
determine a common display mode setting from amongst the first set of display mode settings and the second set of display mode settings; and
generate a common video signal for the integrated GPU and the graphical processing device based on the common display mode setting.

2. The computing device as claimed in claim 1, wherein the common display mode setting comprises a display resolution supported by the integrated GPU, the graphical processing device, or a combination thereof.

3. The computing device as claimed in claim 1, wherein the processor on determining the common display mode setting is to further configure a first display coupled to the integrated GPU and a second display coupled to the graphical processing device, based on the common display mode setting.

4. The computing device as claimed in claim 1, wherein to determine the common display mode setting, the processor is to further:
determine a highest supported setting from amongst the first set;
compare the highest supported setting with each setting within the second set; and
selecting as the common display mode setting, a supported setting from the second set which matches the highest supported setting.

5. The computing device as claimed in claim 1, wherein the processor on detecting the graphical processing device appends an identifier corresponding to the detected graphical processing device to a linked list of a plurality of graphical processing units.

6. The computing device as claimed in claim 1, wherein the graphical processing device is a docking station, a discrete graphical processing unit, an external graphical processing unit, or a combination thereof.

7. The computing device as claimed in claim 1, wherein the processor is to write data corresponding to the common video signal to a frame buffer corresponding to the integrated GPU and another frame buffer corresponding to the graphical processing device.

8. A computing device comprising:
an integrated display;
an integrated graphical processing unit (GPU) coupled to the integrated display;
a processor coupled to the integrated GPU, wherein the processor is to,
on initiation of power-on self-test, detect a graphical processing device, wherein the graphical processing device is coupled to the computing device and a second display, such that the graphical processing device provides a connection between the computing device and the second display;
determine a common display mode setting from amongst a first set of display mode settings supported by the integrated GPU and a second set of display mode settings;
initialize device drivers of the integrated GPU and the graphical processing device; and
generate video signals for the integrated GPU and the graphical processing device based on the common display mode setting, wherein the video signals cause to display a common visual output on the integrated display and the second display.

9. The computing device as claimed in claim 8, wherein to determine the common display mode setting, the processor is to further:
compare a predefined supported setting with each setting within the second set; and
selecting as the common display mode setting, a supported setting from the second set which matches the predefined supported setting.

10. The computing device as claimed in claim 8, wherein the processor on detecting the graphical processing device appends an identifier corresponding to the detected graphical processing device to a linked list of a plurality of graphical processing units.

11. The computing device as claimed in claim 10, wherein the processor is to initialize device drivers of the integrated GPU and the graphical processing device based on the linked list.

12. The computing device as claimed in claim 8, wherein the video signals cause to display a predefined visual output.

13. A non-transitory computer-readable medium comprising computer-readable instructions, which when executed by a processor, on powering on cause a computing device to:
initiate a power-on self-test procedure;
retrieve a first set of display mode settings supported by an integrated graphical processing unit (GPU) of the computing device;
detect a second GPU of the computing device, wherein the second GPU is in communication with the computing device;
retrieve a second set of display mode settings supported by the second GPU;
determine a common display mode setting from amongst the first set of display mode settings and the second set of display mode; and
generate video signals for the integrated GPU and the second GPU based on the common display mode setting.

14. The non-transitory computer-readable medium as claimed in claim 13, wherein the computer-readable instructions are implemented in Unified Extensible Firmware Interface (UEFI) based firmware.

15. The non-transitory computer-readable medium as claimed in claim 13, wherein a display mode from amongst the first set of display settings comprises display resolution.
